(19) United States
(12) Patent Application Publication
(10) Pub. No.: US 2026/0360647 A1
(43) Pub. Date: Nov. 12, 2026

(54) RELAY

(71) Applicant: Xiamen Hongfa Electric Power Controls Co., Ltd., Xiamen, Fujian (CN)

(72) Inventors: Meng WANG, Xiamen, Fujian (CN); Songsheng CHEN, Xiamen, Fujian (CN); Yaosheng HONG, Xiamen, Fujian (CN); Wenguang DAI, Xiamen, Fujian (CN)

(73) Assignee: Xiamen Hongfa Electric Power Controls Co., Ltd., Xiamen, Fujian (CN)

(21) Appl. No.: 19/120,814

(22) PCT Filed: Oct. 9, 2023
(86) PCT No.: PCT/CN2023/123595

§ 371 Date: Apr. 14, 2025

(30) Foreign Application Priority Data
Oct. 12, 2022 (CN) 202211249341.3

(51) Int. Cl. H01H 50/34; H01H 50/04; H01H 50/42; H01H 50/54; H01H 50/60; H01H 50/64

(52) U.S. Cl. CPC H01H 50/34; H01H 50/045; H01H 50/42; H01H 50/546; H01H 50/60; H01H 50/64

(57) ABSTRACT

A relay includes a contact container having a contact chamber; a pair of static contact terminals fixedly disposed relative to the contact container; a holding member, at least partially located within the contact chamber and fixed relative to the contact container; a first magnetizer movably connected to the holding member between a first position and a second position; and a movable member including a movable contact piece and a second magnetizer, the first magnetizer and the second magnetizer are fixedly disposed at two opposite sides of the movable contact piece, the second magnetizer is configured to form a magnetic circuit with the first magnetizer. A first distance between the first magnetizer and the second magnetizer in the first position is greater than a second distance between the first magnetizer and the second magnetizer in the second position.

### CROSS-REFERENCE

This disclosure is the U.S. national phase application of International Application No. PCT/2023/123595, filed on Oct. 19, 2023, which claims priority to Chinese patent application No. 202211249341.3 filed on Oct. 12, 2022, the entire contents of which are incorporated herein by reference.

### TECHNICAL FIELD

The present disclosure relates to the technical field of relays, and more specifically, to a high-voltage DC relay.

### BACKGROUND

A relay is an electronic control device that consists of a control system (also known as the input circuit) and a controlled system (also known as the output circuit). It is commonly used in automatic control circuits. Essentially, a relay functions as an “automatic switch” that uses a smaller current to control a larger current. As such, it plays roles in automatic regulation, safety protection, and circuit switching within electrical systems.

High-voltage DC relays are a type of relay. In order to solve the problem that the contact of high voltage DC relay bounces off because of the electric repulsion generated by short circuit current, related technologies typically employ an anti-short-circuit ring electromagnetic structure. Based on the placement of the upper yoke iron, these structures are further categorized into follow-up type and fixed type. Specifically, the follow-up type structure refers that the upper yoke iron is installed on the movable component of the relay, while the fixed type structure refers that the upper yoke iron is installed in a fixed position other than the movable component. However, although the fixed-type anti-short-circuit structure has strong anti-short-circuit capability, its breaking capacity is weakened due to the negative correlation between anti-short-circuit capability and breaking capacity. On the other hand, the follow-up type anti-short-circuit structure is influenced by the holding force of the movable iron core. When the short-circuit current is high, the iron core will break off, which will lead to the disconnection of contacts, and to increase the holding force of the moving iron core, it is necessary to increase the coil, which is contrary to the small size and light weight.

### SUMMARY

In one aspect of the present disclosure, A relay, including:
a contact container having a contact chamber;
a pair of static contact terminals fixedly disposed relative to the contact container;
a holding member, at least partially located within the contact chamber and fixed relative to the contact container;
a first magnetizer movably connected to the holding member between a first position and a second position; and
a movable member including a movable contact piece and a second magnetizer, wherein two ends of the movable contact piece are configured to come into contact with or separate from the pair of static contact terminals; the first magnetizer is located at a side of the movable contact piece facing the static contact terminals, and the second magnetizer is fixedly disposed at a side of the movable contact piece facing away from the static contact terminals, the second magnetizer is configured to form a magnetic circuit with the first magnetizer; wherein in the first position, a distance between the first magnetizer and the second magnetizer is a first distance, and in the second position, a distance between the first magnetizer and the second magnetizer is a second distance, the first distance is greater than the second distance.

According to some embodiments of the present disclosure, wherein the pair of static contact terminals are connected to the contact container, at least a portion of each of the static contact terminals is located within the contact chamber.

According to some embodiments of the present disclosure, when the first magnetizer is in the first position, a current value flowing through the movable contact piece is less than or equal to a threshold current;
when the current value flowing through the movable contact piece exceeds the threshold current, the first magnetizer moves from the first position to the second position.

According to some embodiments of the present disclosure, the first magnetizer is movably connected to the holding member through a limiting structure, the limiting structure is configured to restrict movement of the first magnetizer relative to the holding member between the first position and the second position.

According to some embodiments of the present disclosure, the limiting structure includes:
a limiting slot provided on one of the first magnetizer and the holding member, the limiting slot extends along a movement direction of the movable contact piece, and a slot wall of the limiting slot having a stopping wall at an end near the second magnetizer; and
a limiting block provided on another of the first magnetizer and the holding member, the limiting block is slidably fitted with the limiting slot, and in the second position, the stopping wall is stopped by the limiting block.

According to some embodiments of the present disclosure, in the first position, a first gap exists between the limiting block and the slot wall of the limiting slot;
in the second position, a second gap exists between the limiting block and the slot wall of the limiting slot;
the first gap is smaller than the second gap.

According to some embodiments of the present disclosure, the contact container further includes a pair of first through-holes and a second through-hole both communicating with the contact chamber; the pair of static contact terminals are respectively pass through the pair of first through-holes;
the relay further includes a connector passes through the second through-hole, the connector includes a first end and a second end, the first end is connected to the contact container, and the second end is connected to the holding member.

According to some embodiments of the present disclosure, the contact container includes:
a yoke plate; and
an insulating cover connected to the yoke plate, the insulating cover and the yoke plate enclose to form the contact chamber;
wherein the first through-holes and the second through-hole are provided in the insulating cover, and the first end of the connector is connected to an outer surface of the insulating cover.

According to some embodiments of the present disclosure, the insulating cover includes a ceramic cover and a frame member, the ceramic cover includes a top wall and a side wall, one end of the side wall is connected around a perimeter of the top wall, and another end of the side wall is connected to the yoke plate through the frame member;
the first through-holes and the second through-hole are provided in the top wall; a first metallization layer is provided around a periphery of the first through-holes on an outer surface of the top wall, and a second metallization layer is provided around a periphery of the second through-hole on an outer surface of the top wall;
the static contact terminals are welded to the top wall through the first metallization layer, and the first end of the connector is welded to the top wall through the second metallization layer.

According to some embodiments of the present disclosure, the top wall and the side wall are separate structures, or the top wall and the side wall are an integrated structure.

According to some embodiments of the present disclosure, the holding member is spaced apart from an inner surface of the top wall.

According to some embodiments of the present disclosure, the contact container includes:
a yoke plate; and
an insulating cover connected to the yoke plate, the insulating cover and the yoke plate enclose to form the contact chamber;
the relay further includes a fixed frame located within the contact chamber and fixedly connected to the yoke plate, the holding member is fixedly connected to the fixed frame.

According to some embodiments of the present disclosure, the relay further includes:
a first elastic member located between the first magnetizer and the holding member, configured to apply an elastic force to the first magnetizer toward the first position.

According to some embodiments of the present disclosure, the holding member includes:
a first bracket fixed relative to the contact container; and
a second bracket detachably connected to the first bracket and enclosing a holding cavity with the first bracket; the first elastic member and the first magnetizer are located within the holding cavity, and the first magnetizer is provided with an accommodation slot on a side facing the second bracket, one end of the first elastic member abuts against the second bracket, and another end abuts against a bottom of the accommodation slot.

According to some embodiments of the present disclosure, the first elastic member is a spring.

According to some embodiments of the present disclosure, the relay further includes a push rod assembly, the push rod assembly including:
a push rod movably disposed relative to the contact container along an axial direction of the push rod;
a base provided at one end of the push rod along the axial direction of the push rod, at least partially extending into the contact chamber; the movable member is movably connected to the base along the axial direction of the push rod; and
a second elastic member connected between the movable member and the base, configured to apply an elastic force to the movable member toward the first magnetizer.

According to some embodiments of the present disclosure, the holding member is located between the pair of static contact terminals.

According to some embodiments of the present disclosure, the holding member is made of a metal material.

According to some embodiments of the present disclosure, in the second position, the second distance between the first magnetizer and the second magnetizer is zero.

### BRIEF DESCRIPTION OF THE DRAWINGS

FIG. 1 shows a perspective view of the relay of the present disclosure, with the housing, electromagnet unit, and arc extinguishing unit removed.

FIG. 2 shows a top view of FIG. 1.

FIG. 3 shows a cross-sectional view along line M-M in FIG. 1.

FIG. 4 shows a perspective view of FIG. 1 with the ceramic cover and frame member removed.

FIG. 5 shows an exploded view of FIG. 1.

FIG. 6 shows a cross-sectional view along line N-N in FIG. 1, with the ceramic cover and frame member removed, and the first magnetizer in the first position.

FIG. 7 shows a partial enlarged view of part X in FIG. 6.

FIG. 8 shows a cross-sectional view along line N-N in FIG. 1, with the ceramic cover, the frame member removed, and the first magnetizer in the second position.

FIG. 9 shows a partial enlarged view of part Y in FIG. 8.

FIG. 10 shows a partial enlarged view of portion P in FIG. 4.

FIG. 11 shows a schematic diagram of the holding member fixedly connected to a fixed frame.

FIG. 12 shows an exploded view of the relay of the present disclosure.

FIG. 13 shows an exploded view of the first bracket, second bracket, and first magnetizer.

### REFERENCE NUMERALS

10. contact container; 101. contact chamber; 102. first through-hole; 103. second through-hole; 11a. insulating cover; 11. ceramic cover; 111. top wall; 112. side wall; 113. first metallization layer; 114. second metallization layer; 12. frame member; 13. yoke plate; 131. third through-hole; 20. static contact terminal; 30. connector; 31. first end of connector; 32. second end of connector; 40. first magnetizer; 401. guide slot; 41. accommodation slot; 42. holding member; 421. first bracket; 422. second bracket; 423. holding cavity; 424. snap hook; 425. snap hole; 426. guide part; 43. limiting structure; 431. limiting slot; 432. limiting block; 433. stopping wall; 434. limiting wall; 435. slot wall; 44. first elastic member; 50. push rod assembly; 51. push rod; 52. base; 53. movable member; 54. movable contact piece; 55. second magnetizer; 56. second elastic member; 57. sliding structure; 571. limiting part; 572. limiting hole; 70. fixed frame; 1100. housing; 1110. first housing; 1120. second housing; 1130. exposure hole; 1200. electromagnet unit; 1210. bobbin; 1220. coil; 1240. movable iron core; 1250. reset member; 1300. arc extinguishing unit; 1310. arc extinguishing magnet; 1320. yoke clip; 1400. sealing unit; 1410. metal cover; p1. first position; p2. second position; h1. first distance; h2. second distance; d1. movement direction; d2. length direction.

### DETAILED DESCRIPTION

Now, exemplary embodiments will be described more fully with reference to the accompanying drawings. However, the exemplary embodiments can be implemented in various forms and should not be construed as limited to the embodiments set forth herein. Rather, these embodiments are provided so that this disclosure will be thorough and complete, and will fully convey the concept of the exemplary embodiments to those skilled in the art. The same reference numerals in the drawings denote the same or similar structures, and thus their detailed descriptions will be omitted.

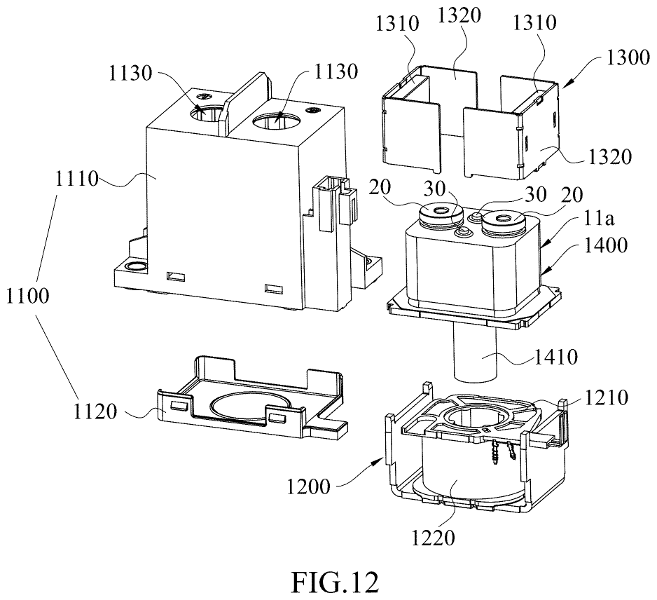

As shown in FIG. 12, FIG. 12 illustrates an exploded schematic diagram of the relay of the present disclosure. The relay includes a housing 1100, an electromagnet unit 1200, an arc extinguishing unit 1300, and a sealing unit 1400. The sealing unit 1400 is disposed inside the housing 1100, and the top of the static contact terminal of the sealing unit 1400 is exposed on the outer surface of the housing 1100 through the exposure hole 1130 of the housing 1100. Both the electromagnet unit 1200 and the arc extinguishing unit 1300 are arranged inside the housing 1100.

As an example, the housing 1100 includes a first housing 1110 and a second housing 1120, which are snap-fitted together to form a chamber for accommodating the electromagnet unit 1200, the arc extinguishing unit 1300, and the sealing unit 1400.

The arc extinguishing unit 1300 is used to extinguish arcs generated between the static contact terminal of the sealing unit 1400 and the movable contact piece.

As an example, the arc extinguishing unit 1300 includes two arc extinguishing magnets 1310. The arc extinguishing magnets 1310 may be permanent magnets, and each arc extinguishing magnet 1310 may be generally cuboid-shaped. The two arc extinguishing magnets 1310 are respectively arranged at both sides of the sealing unit 1400 and are oppositely positioned along the length direction D2 of the movable contact piece.

By arranging two oppositely positioned arc extinguishing magnets 1310, a magnetic field can be formed around the static contact terminal and the movable contact piece. Therefore, arcs generated between the static contact terminal and the movable contact piece will be elongated in opposite directions under the influence of the magnetic field, achieving arc extinguishing.

The arc extinguishing unit 1300 further includes two yoke clips 1320, which are correspondingly positioned with the two arc extinguishing magnets 1310. Moreover, the two yoke clips 1320 surround the sealing unit 1400 and the two arc extinguishing magnets 1310. By designing the yoke clips 1320 to surround the arc extinguishing magnets 1310, the diffusion of the magnetic field generated by the arc extinguishing magnets 1310 can be prevented, ensuring effective arc extinguishing. The yoke clips 1320 are made of soft magnetic materials, which may include but are not limited to iron, cobalt, nickel, and their alloys.

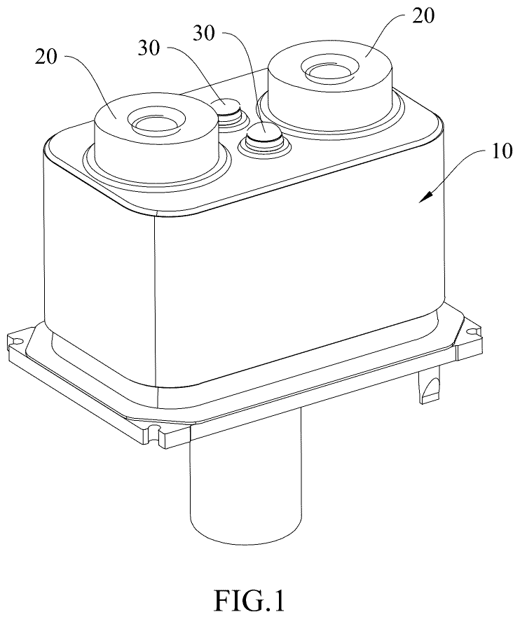

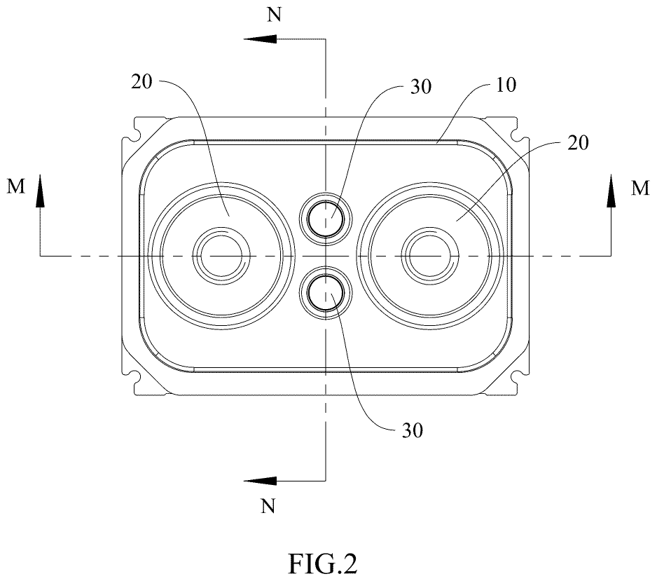

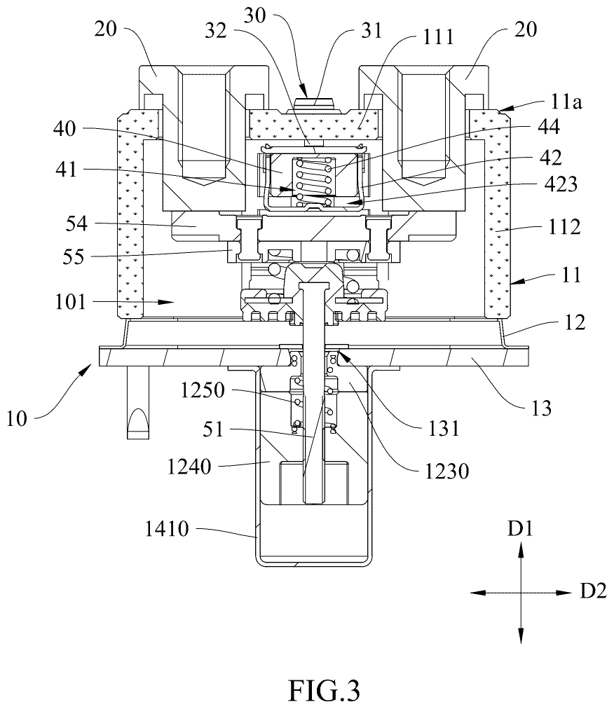

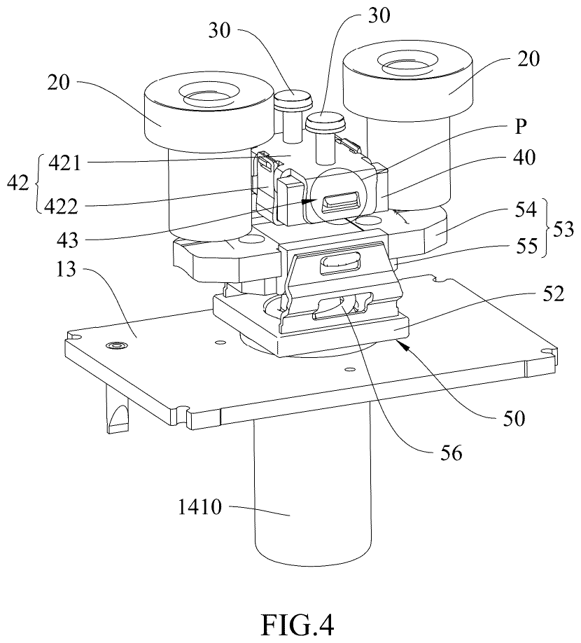

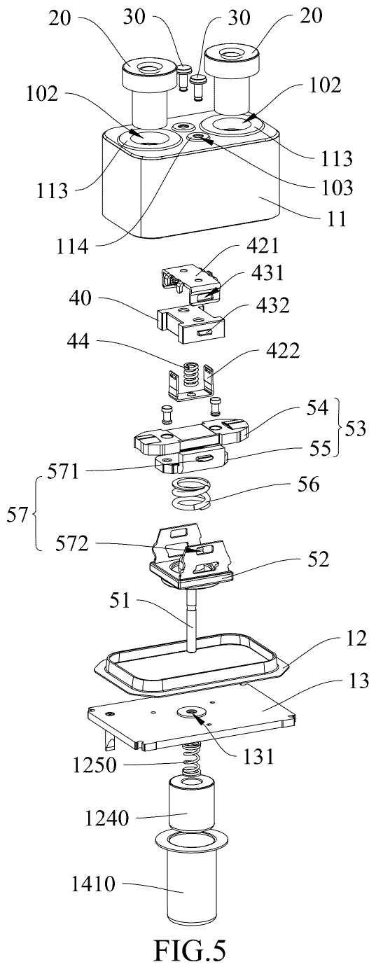

As shown in FIGS. 1 to 5, FIG. 1 illustrates a perspective view of the relay of the present disclosure, with the housing, electromagnet unit, and arc extinguishing unit removed. FIG. 2 illustrates a top view of FIG. 1. FIG. 3 illustrates a cross-sectional view along line M-M in FIG. 1. FIG. 4 illustrates a perspective view of FIG. 1 with the ceramic cover 11 and frame member 12 removed. FIG. 5 illustrates an exploded view of FIG. 1.

The sealing unit 1400 of the present disclosure includes a contact container 10, a pair of static contact terminals 20, a push rod assembly 50, a holding member 42, a first magnetizer 40, and a first elastic member 44.

It should be understood that the terms “include” and “have” and any variations thereof in this disclosure are intended to cover non-exclusive inclusion. For example, a process, method, system, product, or device that includes a series of steps or units is not limited to the listed steps or units but may optionally include steps or units not listed, or other inherent steps or components of these processes, methods, products, or devices.

The contact container 10 has a contact chamber 101 inside. The contact container 10 may include an insulating cover 11a and a yoke plate 13, with the insulating cover 11a covering one side of the yoke plate 13. The insulating cover 11a and the yoke plate 13 together enclose the contact chamber 101.

The insulating cover 11a includes a ceramic cover 11 and a frame member 12. The ceramic cover 11 is connected to the yoke plate 13 through the frame member 12. The frame member 12 may be a ring-shaped metal component, such as iron-nickel alloy, with one end connected to the opening edge of the ceramic cover 11, for example, by laser welding, brazing, resistance welding, or adhesive bonding. The other end of the frame member 12 is connected to the yoke plate 13, also by methods such as laser welding, brazing, resistance welding, or adhesive bonding. By providing the frame member 12 between the ceramic cover 11 and the yoke plate 13, the connection between the ceramic cover 11 and the yoke plate 13 is facilitated.

The ceramic cover 11 includes a top wall 111 and a side wall 112, with one end of the side wall 112 connected around the perimeter of the top wall 111, and the other end connected to the yoke plate 13 through the frame member 12.

The contact container 10 also has a pair of first through-holes 102 and a second through-hole 103, both communicating with the contact chamber 101. The first through-holes 102 are for the static contact terminals 20 to pass through, and the second through-hole 103 is for a connector 30 to pass through.

As an example, the first through-holes 102 and the second through-hole 103 are both provided in the top wall 111 of the ceramic cover 11. The second through-hole 103 may be located between the two first through-holes 102, meaning the connector 30 is positioned between the pair of static contact terminals 20.

The pair of static contact terminals 20 are connected to the contact container 10, with at least part of each static contact terminal 20 located inside the contact chamber 101. One of the pair of static contact terminals 20 serves as the current input terminal, and the other serves as the current output terminal.

The pair of static contact terminals 20 pass through the pair of first through-holes 102 in one-to-one correspondence and are connected to the top wall 111 of the ceramic cover 11, for example, by welding.

The bottom of the static contact terminal 20 serves as the static contact, which may be integrally or separately provided at the bottom of the static contact terminal 20.

At least part of the holding member 42 is located inside the contact chamber 101 and is fixed relative to the contact container 10, used to connect the first magnetizer 40.

In one embodiment, the holding member 42 is located between the pair of static contact terminals 20. By positioning the holding member 42 between the pair of static contact terminals 20, excessive occupation of space inside the contact chamber 101 by the holding member 42 is avoided, which is beneficial for miniaturizing the relay.

In one embodiment, the holding member 42 is made of metal to enhance its structural strength.

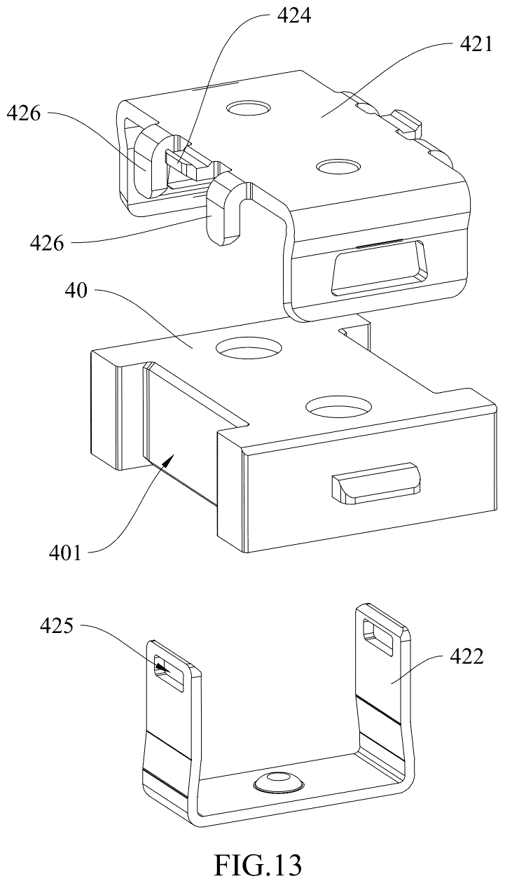

As shown in FIGS. 5 and 13, FIG. 13 illustrates an exploded view of the first bracket, second bracket, and first magnetizer. As an example, the holding member 42 may include a first bracket 421 and a second bracket 422. The first bracket 421 is fixed relative to the contact container 10, and the second bracket 422 is detachably connected to the first bracket 421, enclosing a holding cavity 423 together with the first bracket 421. This holding cavity 423 is used to accommodate the first magnetizer 40 and the first elastic member 44.

It should be understood that the detachable connection between the first bracket 421 and the second bracket 422, enclosing a holding cavity 423 for accommodating the first magnetizer 40 and the first elastic member 44, not only facilitates the fixed installation of the holding member 42 relative to the contact container 10 but also makes it easy to install the first magnetizer 40 and the first elastic member 44 into the holding cavity 423.

As an example, the first bracket 421 and the second bracket 422 may be connected through snap hooks 424 and snap holes 425, but this is not limiting. For example, the snap hooks 424 may be provided on one of the first bracket 421 and the second bracket 422, and the snap holes 425 may be provided on the other.

The first magnetizer 40 is arranged inside the contact chamber 101 and is movably connected to the holding member 42 between a first position P1 and a second position P2.

Please continue to refer to FIG. 13. A guiding structure is provided between the first magnetizer 40 and the holding member 42 to guide the movement of the first magnetizer 40 relative to the holding member 42 between the first position P1 and the second position P2, preventing the first magnetizer 40 from shaking.

As an example, the guiding structure includes a guiding part 426 and a guiding slot 401. The guiding part 426 may be arranged inside the guiding slot 401 and is slidably fitted with the guiding slot 401. The guiding part 426 may be provided on one of the first magnetizer 40 and the holding member 42, and the guiding slot 401 may be provided on the other.

In this embodiment, the guiding part 426 is provided on the first bracket 421, and the guiding slot 401 is provided on the first magnetizer 40.

Of course, in other embodiments, the guiding part 426 may also be provided on the first magnetizer 40, and the guiding slot 401 may be provided on the first bracket 421.

The push rod assembly 50 is movably disposed relative to the contact container 10 along the axial direction of the rod (i.e., along the movement direction D1 of the movable contact piece). The push rod assembly 50 may include a push rod 51, a base 52, a movable member 53, and a second elastic member 56.

The yoke plate 13 has a third through-hole 131, which penetrates through two opposite sides of the yoke plate 13 along its thickness direction and communicates with the contact chamber 101 of the contact container 10. The push rod 51 is movably passed through the third through-hole 131 along its axial direction. One axial end of the push rod 51 is provided with the base 52, and at least part of the base 52 is located inside the contact chamber 101.

The movable member 53 is movably connected to the base 52 along the axial direction of the push rod 51. The movable member 53 includes a movable contact piece 54 and a second magnetizer 55. The two ends of the movable contact piece 54 are used to come into contact with or separate from the pair of static contact terminals 20. The first magnetizer 40 is located at the side of the movable contact piece 54 facing the static contact terminals 20, and the second magnetizer 55 is fixedly disposed at the side of the movable contact piece 54 facing away from the static contact terminals 20. In other words, along the axial direction of the push rod 51, the movable contact piece 54 is located between the first magnetizer 40 and the second magnetizer 55.

As an example, the second magnetizer 55 and the movable contact piece 54 may be fixedly connected by rivets, but this is not limiting.

It should be understood that both the first magnetizer 40 and the second magnetizer 55 can be made of materials such as iron, cobalt, nickel, and their alloys.

In one embodiment, the first magnetizer 40 may be linear shape, and the second magnetizer 55 may be U-shaped, but this is not limiting. It should be understood that both the first magnetizer 40 and the second magnetizer 55 may include multiple stacked magnetic sheets.

The two ends of the movable contact piece 54 are used to contact the bottoms of the pair of static contact terminals 20, achieving contact closure. The two ends of the movable contact piece 54 along its length direction D2 can serve as movable contacts. The movable contacts at the ends of the movable contact piece 54 may protrude from other parts of the movable contact piece 54 or be flush with them.

It should be understood that the movable contacts may be integrally or separately provided at the two ends of the movable contact piece 54 along its length direction D2.

The second elastic member 56 is connected between the movable member 53 and the base 52, used to apply an elastic force to the movable member 53 toward the static contact terminals 20/first magnetizer 40.

As an example, one end of the second elastic member 56 abuts against the base 52, and the other end abuts against the second magnetizer 55 of the movable member 53. Of course, in other embodiments, the second magnetizer 55 may have a through-hole, and the other end of the second elastic member 56 may pass through the through-hole of the second magnetizer 55 to abut against the movable contact piece 54.

Both the first elastic member 44 and the first magnetizer 40 may be located inside the holding cavity 423. The first elastic member 44 may be positioned between the first magnetizer 40 and the holding member 42, used to apply an elastic force to the first magnetizer 40 toward the first position P1.

The side of the first magnetizer 40 facing the second bracket 422 is provided with an accommodation slot 41. One end of the first elastic member 44 abuts against the second bracket 422, and the other end abuts against the bottom of the accommodation slot 41.

It should be understood that both the first elastic member 44 and the second elastic member 56 may be springs, but this is not limiting.

As shown in FIG. 5, the push rod assembly 50 further includes a sliding structure 57, which is connected between the base 52 and the movable member 53. The movable member 53 can slide relative to the base 52 through the sliding structure 57. The sliding structure 57 includes a limiting hole 572 and a limiting part 571 that fit with each other. The limiting part 571 is slidably inserted into the limiting hole 572.

In this embodiment, the base 52 is directly connected to the movable member 53 through the limiting structure 57, making the assembly between the base 52 and the movable member 53 simpler. Moreover, since there are no other components above the movable member 53, interference between these components and the first magnetizer 40 during overtravel is avoided.

It should be understood that the limiting hole 572 may be a through-hole or a blind hole.

As an example, the base 52 is provided with the limiting hole 572, and the movable member 53 is provided with the limiting part 571. Further, the second magnetizer 55 is provided with the limiting part 571.

Of course, in other embodiments, the push rod assembly 50 may also adopt other structures, which will not be listed here.

Please continue to refer to FIGS. 3, 5, and 12. The sealing unit 1400 further includes a metal cover 1410, which is connected to the side of the yoke plate 13 facing away from the insulating cover 11a and covers the third through-hole 131 on the yoke plate 13. The metal cover 1410 and the yoke plate 13 enclose a chamber for accommodating the static iron core 1230 and the movable iron core 1240 of the electromagnet unit 1200, which will be described in detail below.

The electromagnet unit 1200 includes a bobbin 1210, a coil 1220, a static iron core 1230, a movable iron core 1240, and a reset member 1250. The bobbin 1210 is hollow and cylindrical, made of insulating material. The metal cover 1410 is inserted inside the bobbin 1210. The coil 1220 surrounds the bobbin 1210. The static iron core 1230 is fixed inside the metal cover 1410, with part of the static iron core 1230 extending into the third through-hole 131. The static iron core 1230 has a perforation corresponding to the position of the third through-hole 131, allowing the push rod 51 to pass through. The movable iron core 1240 is movably arranged inside the metal cover 1410 and is positioned opposite to the static iron core 1230. The movable iron core 1240 is connected to the push rod 51 and is attracted to the static iron core 1230 when the coil 1220 is energized. The movable iron core 1240 and the push rod 51 may be connected by screwing, riveting, welding, or other methods.

The reset member 1250 is located inside the metal cover 1410 and is positioned between the static iron core 1230 and the movable iron core 1240. It is used to reset the movable iron core 1240 when the coil 1220 is de-energized. The reset member 1250 may be a spring and is sleeved around the push rod 51.

It should be noted that when the coil 1220 is energized, the movable iron core 1240 can drive the push rod assembly 50 to move upward through the push rod 51. When the movable member 53 contacts the static contact terminals 20, the movable member 53 is stopped by the static contact terminals 20, while the push rod 51 and the base 52 continue to move upward until the overtravel is completed.

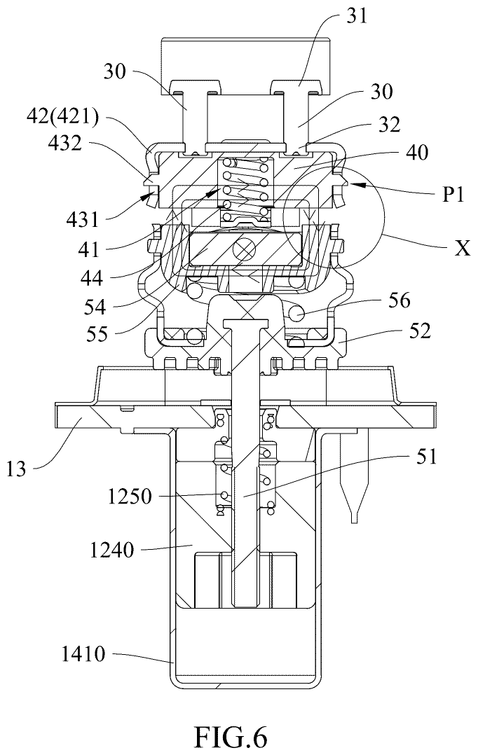

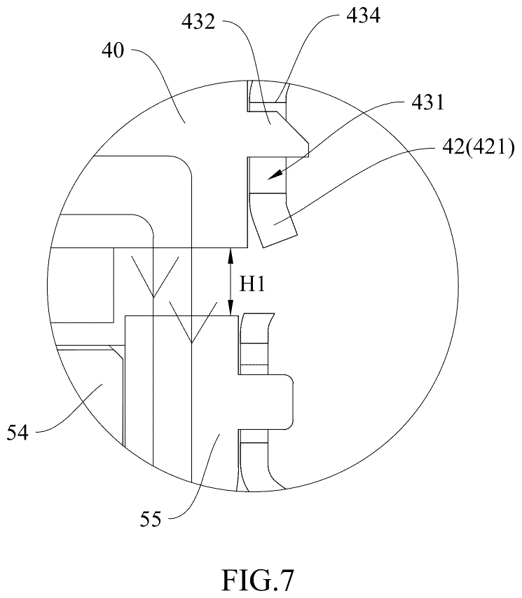

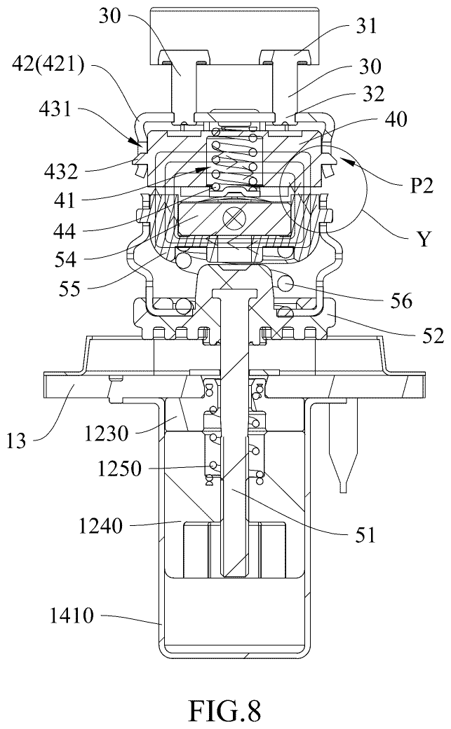

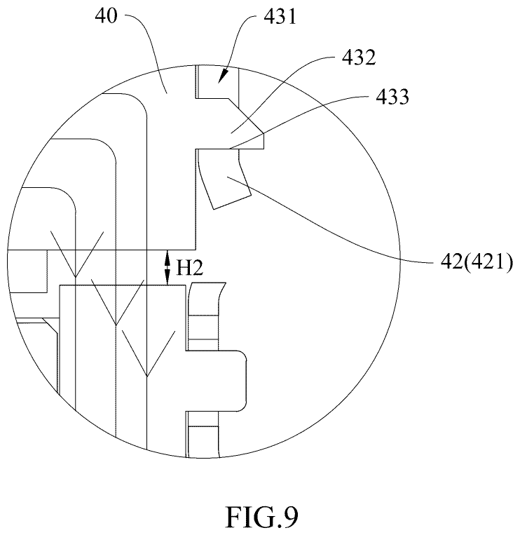

As shown in FIGS. 6 and 9, FIG. 6 illustrates a cross-sectional view along line N-N in FIG. 2, with the ceramic cover and frame member removed, and the first magnetizer 40 in the first position P1. FIG. 7 shows a partial enlarged view of area X in FIG. 6. FIG. 8 illustrates a cross-sectional view along line N-N in FIG. 2, with the ceramic cover and frame member removed, and the first magnetizer 40 in the second position P2. FIG. 9 shows a partial enlarged view of area Y in FIG. 8. In the first position P1, the distance between the first magnetizer 40 and the second magnetizer 55 is the first distance H1. In the second position P2, the distance between the first magnetizer 40 and the second magnetizer 55 is the second distance H2, the first distance H1 is greater than the second distance H2.

It should be noted that the movable contact piece 54 of the present disclosure is located between the first magnetizer 40 and the second magnetizer 55. When the two ends of the movable contact piece 54 contact the pair of static contact terminals 20, a magnetic circuit surrounding the movable contact piece 54 is formed between the first magnetizer 40 and the second magnetizer 55, generating a magnetic attraction force along the contact pressure direction between the first magnetizer 40 and the second magnetizer 55. This magnetic attraction force can counteract the electromagnetic repulsion force generated by the short-circuit current between the movable contact piece 54 and the static contact terminals 20, ensuring that the movable contact piece 54 and the static contact terminals 20 do not bounce off.

It should be understood that when the current flowing through the movable contact piece 54 is constant, the magnitude of the magnetic attraction force generated between the first magnetizer 40 and the second magnetizer 55 is inversely proportional to the distance between them. The smaller the distance, the greater the magnetic attraction force.

To counteract the electromagnetic repulsion force generated by the short-circuit current and prevent the movable contact piece 54 from bouncing off the static contact terminals 20, the distance between the first magnetizer 40 and the second magnetizer 55 should be designed to be smaller, thereby increasing the magnetic attraction force between them.

To facilitate timely breaking, the distance between the first magnetizer 40 and the second magnetizer 55 should be designed to be larger, reducing the magnetic attraction force between them and avoiding excessive magnetic attraction force that could affect timely breaking.

From this, it can be seen that when the distance between the first magnetizer 40 and the second magnetizer 55 is fixed, it is impossible to balance both anti-short circuit and limit breaking capability.

In this embodiment, by making the first magnetizer 40 movable, the distance between the first magnetizer 40 and the second magnetizer 55 can be adjusted according to the current value, thereby changing the magnetic attraction force between them to balance anti-short circuit and limit breaking capability.

Specifically, as shown in FIGS. 6 and 7, the relay is in its normal working state, and the current flowing through the movable contact piece 54 is less than or equal to a threshold current, for example, the current is less than or equal to 2000 A. Since the current value is relatively small, the magnetic attraction force between the first magnetizer 40 and the second magnetizer 55 is also small, and the magnetic attraction force is less than the elastic pre-compression force of the first elastic member 44. Thus, the elastic force of the first elastic member 44 can counteract the magnetic attraction force between the first magnetizer 40 and the second magnetizer 55, keeping the first magnetizer 40 in the first position P1. When the first magnetizer 40 is in the first position P1, the distance between the first magnetizer 40 and the second magnetizer 55 is the first distance H1. For example, the first distance H1 can be 1.5 mm, but this is not limiting.

It should be understood that the magnitude of the threshold current can be adjusted according to different types of relays. For instance, if the maximum breaking current of the relay is larger, the threshold current can also be set higher, ensuring that the first magnetizer 40 remains in the first position P1 during normal operation and does not move toward the second position P2.

As shown in FIGS. 8 and 9, when the current flowing through the movable contact piece 54 exceeds the threshold current, for example, greater than 2000 A, the magnetic attraction force between the first magnetizer 40 and the second magnetizer 55 increases proportionally with the current. When the magnetic attraction force exceeds the elastic preload of the first elastic member 44, the first magnetizer 40 is attracted by the magnetic force and moves toward the second magnetizer 55, reducing the distance between them. Since the magnetic gap is inversely proportional to the magnetic attraction force, a smaller distance results in a greater magnetic attraction force. When a short-circuit current (much larger than the threshold current) flows, an even greater magnetic attraction force is generated between the first magnetizer 40 and the second magnetizer 55. This magnetic attraction force can compress the first elastic member 44, causing the first magnetizer 40 to move to the second position P2, where the distance between the first magnetizer 40 and the second magnetizer 55 is the second distance H2. The second distance H2 is smaller than the first distance H1, and the reduced distance increases the magnetic attraction force between the first magnetizer 40 and the second magnetizer 55. Therefore, the first magnetizer 40 can attract the second magnetizer 55 with this increased magnetic force, which can counteract the electromagnetic repulsion force generated by the short-circuit current, ensuring that the movable contact piece 54 does not bounce off the static contact terminals 20.

Thus, the relay of the present disclosure has two key advantages: first, the first magnetizer 40 is fixed relative to the contact container 10 through the holding member 42, ensuring that the holding force of the first magnetizer 40 is provided by the contact container 10, which effectively enhances the upper limit of anti-short circuit current and ensures reliability of anti-short circuit. Second, the first magnetizer 40 is movably connected to the holding member 42, allowing the distance between the first magnetizer 40 and the second magnetizer 55 to be adjusted based on the current value, thereby changing the magnetic attraction force between them. This design meets both anti-short circuit and overload breaking requirements.

Notably, as the first magnetizer 40 moves from the first position P1 to the second position P2, the first elastic member 44 is gradually compressed, increasing the reverse elastic force applied to the first magnetizer 40. When the current flowing through the movable contact piece 54 exceeds the threshold current but has not yet reached the short-circuit current, the increasing reverse elastic force keeps the first magnetizer 40 at an intermediate position between the first position P1 and the second position P2. When the current reaches the short-circuit current, the magnetic attraction force between the first magnetizer 40 and the second magnetizer 55 becomes strong enough to overcome the reverse elastic force of the first elastic member 44, causing the first magnetizer 40 to continue moving toward the second position P2 and further compressing the first elastic member 44 until the first magnetizer 40 reaches the second position P2.

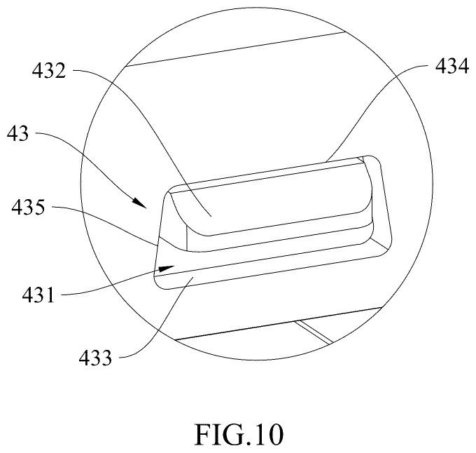

As shown in FIGS. 5 and 10, FIG. 10 illustrates a partial enlarged view of part P in FIG. 4. The first magnetizer 40 is movably connected to the holding member 42 through a limiting structure 43, which restricts the movement of the first magnetizer 40 relative to the holding member 42 between the first position P1 and the second position P2.

The limiting structure 43 includes a limiting slot 431 and a limiting block 432. The limiting slot 431 is provided on one of the first magnetizer 40 and the holding member 42, and extends along the movement direction D1 of the movable contact piece 54. The limiting block 432 is provided on the other of the first magnetizer 40 and the holding member 42 and is slidably fitted with the limiting slot 431.

In this embodiment, the limiting slot 431 is formed on the holding member 42, specifically on the first bracket 421. The limiting block 432 is formed on the first magnetizer 40, specifically protruding from the side wall of the first magnetizer 40.

Of course, in other embodiments, the limiting slot 431 can also be formed on the first magnetizer 40, and the limiting block 432 can be formed on the holding member 42.

When the first magnetizer 40 is in the first position P1, there is a first gap between the limiting block 432 and the slot wall 435 of the limiting slot 431. When the first magnetizer 40 is in the second position P2, there is a second gap between the limiting block 432 and the slot wall 435. The first gap is smaller than the second gap.

Since the first gap is smaller than the second gap, the limiting slot 431 has a structure where one end is larger and the other end is smaller. As the first magnetizer 40 moves from the first position P1 to the second position P2, the gap between the limiting block 432 and the slot wall 435 increases, preventing friction and jamming between them.

As shown in FIGS. 8 and 9, the slot wall of the limiting slot 431 near the second magnetizer 55 has a stopping wall 433. When the first magnetizer 40 moves to the second position P2, the stopping wall 433 is stopped by the limiting block 432. At this point, the distance between the first magnetizer 40 and the second magnetizer 55 is the second distance H2. By stopping the stopping wall 4332 with the limiting block 43, the first magnetizer 40 is fixed relative to the contact container 10, providing a stable and reliable magnetic attraction force on the second magnetizer 55 to meet anti-short circuit requirements.

It should be understood that when the first magnetizer 40 moves to the second position P2, i.e., when the stopping wall 433 is stopped by the limiting block 432, the first magnetizer 40 and the second magnetizer 55 can either be in contact or spaced apart from each other. When they are in contact, the second distance H2 can be considered zero.

As shown in FIGS. 6 and 7, when the first magnetizer 40 is in the first position P1, under the elastic force of the first elastic member 44, the first magnetizer 40 abuts against the first bracket 421 of the holding member 42, while the limiting block 432 is spaced apart from the limiting wall 434 of the limiting slot 431.

Of course, in other embodiments, the first magnetizer 40 can also be kept in the first position P1 within the holding member 42 by having the limiting block 432 abut against another limiting wall 434 opposite to the stopping wall 433 under the elastic force of the first elastic member 44, ensuring the first magnetizer 40 remains stably in the holding member 42.

As shown in FIGS. 5, 6, and 8, the relay also includes a connector 30, which passes through the second through-hole 103 and includes a first end 31 and a second end 32. The first end 31 is connected to the contact container 10, and the second end 32 is connected to the holding member 42.

In this embodiment, the second end 32 of the connector 30 is connected to the first bracket 421.

The contact container 10 is provided with a second through-hole 103, and the connector 30 passes through the second through-hole 103, and is connected to the contact container 10. The holding member 42 is connected to the connector 30. The holding member 42 is connected to the contact container 10 through the connector 30 rather than directly connected to the contact container 10, making the connection process unobstructed and visible, which is both convenient and ensures reliability of connection.

Furthermore, both the first through-hole 102 and the second through-hole 103 are provided on the top wall 111 of the ceramic cover 11, and the first end 31 of the connector 30 is connected to the outer surface of the top wall 111.

On the outer surface of the top wall 111, a first metallization layer 113 is provided around the first through-hole 102, and a second metallization layer 114 is provided around the second through-hole 103. The static contact terminals 20 are welded to the top wall 111 through the first metallization layer 113, and the first end 31 of the connector 30 is welded to the top wall 111 through the second metallization layer 114.

Compared to the inner surface of the ceramic cover 11, the outer surface of the top wall 111 is easier to form a welding plane. Additionally, since the top wall 111 needs to dispose the static contact terminals 20, and welding the static contact terminals 20 to the top wall 111 also requires a metallization layer around the first through-hole 102, the second metallization layer 114 around the second through-hole 103 can be processed simultaneously. Therefore, by welding the connector 30 to the outer surface of the top wall 111, only the outer surface needs to be metallized, simplifying the processing steps.

The holding member 42 is spaced apart from the inner surface of the top wall 111, which creates a gap between the holding member 42 and the inner surface of the top wall 111. Since the holding member 42 does not directly contact the inner surface of the top wall 111, the presence of the holding member 42 does not affect the creepage distance of the static contact terminals 20.

In one embodiment, the top wall 111 and the side wall 112 are separate structures and are connected by welding.

It should be understood that designing the ceramic cover 11 with separate top wall 111 and side wall 112 makes it easier to connect the connector 30 to the top wall 111. Of course, the top wall 111 and the side wall 112 can also be connected by adhesive.

Specifically, since the top wall 111 is plate-shaped, it is easier to process the first through-hole 102, second through-hole 103, first metallization layer 113, and second metallization layer 114 on the top wall 111. Furthermore, the plate-shaped structure also makes it easier to weld the connector 30 and the top wall 111, as well as the static contact terminals 20 and the top wall 111.

Of course, in another embodiment, the top wall 111 and the side wall 112 can also be an integrated structure.

The connection between the second end 32 of the connector 30 and the holding member 42 can be achieved in various ways, such as welding, riveting, or adhesive bonding.

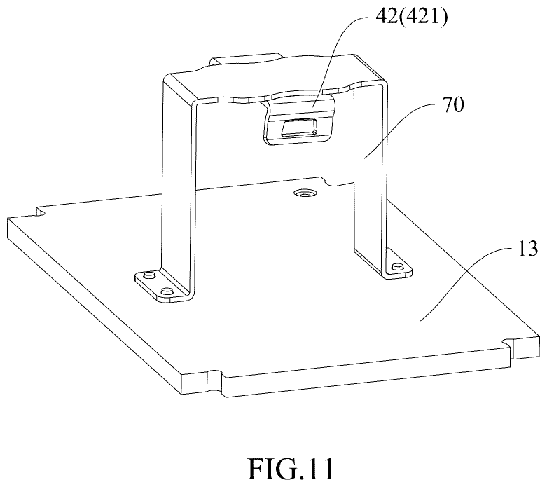

As shown in FIG. 11, FIG. 11 illustrates the holding member 42 fixedly connected to the fixed frame 70. The specific fixing mode of the holding member 42 relative to the contact container 10, in addition to the above-mentioned fixing the holding member 42 to the ceramic cover 11, the holding member 42 can also be fixedly connected to a fixed frame 70.

Specifically, the relay also includes the fixed frame 70, which is located inside the contact chamber 101 and fixedly connected to the yoke plate 13. The holding member 42 is fixedly connected to the fixed frame 70. For example, the first bracket 421 of the holding member 42 can be riveted to the fixed frame 70, but this is not limiting.

At least one embodiment of the above disclosure has the following advantages or beneficial effects:

The relay of the present disclosure, on one hand, positions the first magnetizer on a holding member fixed relative to the contact container, ensuring that the holding force of the first magnetizer is provided by the contact container. In this way, the upper limit of anti-short circuit current capacity can be effectively improved, and the reliability of anti-short circuit current can be ensured. On the other hand, the first magnetizer is movably connected to the holding member, allowing the distance between the first magnetizer and the second magnetizer to be adjusted according to the current value, thereby changing the magnetic attraction force between the first magnetizer and the second magnetizer, and meeting both anti-short circuit and overload breaking requirements.

It should be understood that the various embodiments/implementations provided in this disclosure can be combined without causing contradictions, and examples will not be listed here.

In this disclosure, terms such as “first” “second” and “third” are used for descriptive purposes only and should not be interpreted as indicating or implying relative importance. Terms such as “a pair” or “a” are used to introduce technical features and should not be interpreted as limiting the specific quantity of the feature unless explicitly stated. The term “multiple” refers to two or more unless explicitly stated. Terms such as “install” “connect” “link” and “fix” should be interpreted broadly. For example, “connect” can mean fixed connection, detachable connection, or integrated connection; “link” can mean direct connection or indirect connection through an intermediary. Those skilled in the art can understand the specific meanings of these terms in this disclosure based on the context.

In the description of this disclosure, it should be understood that terms such as “upper” “lower” “left” “right” “front” and “back” indicate orientations or positional relationships based on the drawings. These terms are used to facilitate the description of the disclosure and simplify the explanation, and they do not imply that the described device or unit must have a specific orientation or be constructed and operated in a specific orientation. Therefore, these terms should not be interpreted as limiting the disclosure.

In the description of this specification, terms such as “one embodiment” “some embodiments” and “specific embodiments” mean that the specific features, structures, materials, or characteristics described in the embodiment or example are included in at least one embodiment or example of this disclosure. In this specification, the schematic descriptions of these terms do not necessarily refer to the same embodiment or example. Moreover, the specific features, structures, materials, or characteristics described can be combined in any suitable manner in one or more embodiments or examples.

The above are only preferred embodiments of this disclosure and are not intended to limit the disclosure. For those skilled in the art, various modifications and changes can be made to this disclosure. Any modifications, equivalent replacements, or improvements made within the spirit and principles of this disclosure should be included within the scope of protection of this disclosure.

1. A relay, comprising:
a contact container having a contact chamber;
a pair of static contact terminals fixedly disposed relative to the contact container;
a holding member, at least partially located within the contact chamber and fixed relative to the contact container;
a first magnetizer movably connected to the holding member between a first position and a second position; and
a movable member comprising a movable contact piece and a second magnetizer, wherein two ends of the movable contact piece are configured to come into contact with or separate from the pair of static contact terminals; the first magnetizer is located at a side of the movable contact piece facing the static contact terminals, and the second magnetizer is fixedly disposed at a side of the movable contact piece facing away from the static contact terminals, the second magnetizer is configured to form a magnetic circuit with the first magnetizer; wherein in the first position, a distance between the first magnetizer and the second magnetizer is a first distance, and in the second position, a distance between the first magnetizer and the second magnetizer is a second distance, the first distance is greater than the second distance.

2-18. (canceled)

19. The relay according to claim 1, wherein the pair of static contact terminals are connected to the contact container, at least a portion of each of the static contact terminals is located within the contact chamber.

20. The relay according to claim 1, wherein, when the first magnetizer is in the first position, a current value flowing through the movable contact piece is less than or equal to a threshold current;
when the current value flowing through the movable contact piece exceeds the threshold current, the first magnetizer moves from the first position to the second position.

21. The relay according to claim 1, wherein the first magnetizer is movably connected to the holding member through a limiting structure, the limiting structure is configured to restrict movement of the first magnetizer relative to the holding member between the first position and the second position.

22. The relay according to claim 21, wherein the limiting structure comprises:
a limiting slot provided on one of the first magnetizer and the holding member, the limiting slot extends along a movement direction of the movable contact piece, and a slot wall of the limiting slot having a stopping wall at an end near the second magnetizer; and
a limiting block provided on another of the first magnetizer and the holding member, the limiting block is slidably fitted with the limiting slot, and in the second position, the stopping wall is stopped by the limiting block.

23. The relay according to claim 22, wherein, in the first position, a first gap exists between the limiting block and the slot wall of the limiting slot;
in the second position, a second gap exists between the limiting block and the slot wall of the limiting slot;
the first gap is smaller than the second gap.

24. The relay according to claim 1, wherein the contact container further comprises a pair of first through-holes and a second through-hole both communicating with the contact chamber; the pair of static contact terminals are respectively pass through the pair of first through-holes;
the relay further comprises a connector passes through the second through-hole, the connector comprises a first end and a second end, the first end is connected to the contact container, and the second end is connected to the holding member.

25. The relay according to claim 24, wherein the contact container comprises:
a yoke plate; and
an insulating cover connected to the yoke plate, the insulating cover and the yoke plate enclose to form the contact chamber;
wherein the first through-holes and the second through-hole are provided in the insulating cover, and the first end of the connector is connected to an outer surface of the insulating cover.

26. The relay according to claim 25, wherein the insulating cover comprises a ceramic cover and a frame member, the ceramic cover comprises a top wall and a side wall, one end of the side wall is connected around a perimeter of the top wall, and another end of the side wall is connected to the yoke plate through the frame member;
the first through-holes and the second through-hole are provided in the top wall; a first metallization layer is provided around a periphery of the first through-holes on an outer surface of the top wall, and a second metallization layer is provided around a periphery of the second through-hole on an outer surface of the top wall;
the static contact terminals are welded to the top wall through the first metallization layer, and the first end of the connector is welded to the top wall through the second metallization layer.

27. The relay according to claim 26, wherein the top wall and the side wall are separate structures, or the top wall and the side wall are an integrated structure.

28. The relay according to claim 26, wherein the holding member is spaced apart from an inner surface of the top wall.

29. The relay according to claim 1, wherein the contact container comprises:
a yoke plate; and
an insulating cover connected to the yoke plate, the insulating cover and the yoke plate enclose to form the contact chamber;
the relay further comprises a fixed frame located within the contact chamber and fixedly connected to the yoke plate, the holding member is fixedly connected to the fixed frame.

30. The relay according to claim 1, wherein the relay further comprises:
a first elastic member located between the first magnetizer and the holding member, configured to apply an elastic force to the first magnetizer toward the first position.

31. The relay according to claim 30, wherein the holding member comprises:
a first bracket fixed relative to the contact container; and
a second bracket detachably connected to the first bracket and enclosing a holding cavity with the first bracket; the first elastic member and the first magnetizer are located within the holding cavity, and the first magnetizer is provided with an accommodation slot on a side facing the second bracket, one end of the first elastic member abuts against the second bracket, and another end abuts against a bottom of the accommodation slot.

32. The relay according to claim 30, wherein the first elastic member is a spring.

33. The relay according to claim 1, wherein the relay further comprises a push rod assembly, the push rod assembly comprising:
a push rod movably disposed relative to the contact container along an axial direction of the push rod;
a base provided at one end of the push rod along the axial direction of the push rod, at least partially extending into the contact chamber; the movable member is movably connected to the base along the axial direction of the push rod; and
a second elastic member connected between the movable member and the base, configured to apply an elastic force to the movable member toward the first magnetizer.

34. The relay according to claim 1, wherein the holding member is located between the pair of static contact terminals.

35. The relay according to claim 1, wherein the holding member is made of a metal material.

36. The relay according to claim 1, wherein, in the second position, the second distance between the first magnetizer and the second magnetizer is zero.
